(19) United States
(12) Patent Application Publication
(10) Pub. No.: US 2009/0108491 A1
(43) Pub. Date: Apr. 30, 2009

(54) Mold, mold image and method for making a molded article

(75) Inventor: Shawn M. Frayne, Tampa, FL (US)

Correspondence Address: Sealed Air Corporation, P.O.Box 464, Duncan, SC, 29334, US

(73) Assignee: Sealed Air Corporation (US)

(21) Appl. No.: 11/977,617

(22) Filed: Oct. 25, 2007

(51) Int. Cl. B28B 7/02; B29C 33/42

(52) U.S. Cl. 264/226; 425/175

(57) ABSTRACT

A mold image assembly includes a plurality of contact elements assembled in a defined space such that the contact elements are independently movable, with a first end of the contact elements collectively forming a first surface and a second end of the contact elements collectively forming a second surface. The first surface is adapted to be brought into contact with an object such that the first surface assumes an altered contour that substantially conforms to a contour of the object, and the second surface assumes a correspondingly altered contour. The contact elements are further adapted to be joined together to thereby secure the altered contour of the second surface as a mold image.

### BACKGROUND OF THE INVENTION

The present invention relates to molded articles. More specifically, the invention relates to a mold and mold image associated with the mold, to a method for making the mold, and to a method for making a molded article, e.g., a molded foam article such as a packaging cushion.

Foam-in-place packaging is a highly useful technique for on-demand protection of packaged products. In its most basic form, foam-in-place packaging comprises injecting foamable compositions from a dispenser into a container that holds a product to be cushioned. Typically, the product is wrapped in plastic to keep it from direct contact with the rising (expanding) foam. As the foam rises, it expands into the remaining space between the product and its container (e.g. a box formed of corrugated paperboard), thus forming a custom cushion for the product.

A common foaming composition is formed by mixing an isocyanate compound with a hydroxyl-containing material, such as a polyol (i.e., a compound that contains multiple hydroxyl groups), typically in the presence of water and a catalyst. The isocyanate and polyol precursors react to form polyurethane. At the same time, the water reacts with the isocyanate compound to produce carbon dioxide. The carbon dioxide causes the polyurethane to expand into a foamed cellular structure, i.e., a polyurethane foam, which serves to protect the packaged product.

In other types of foam-in-place packaging, the foam precursors are injected into a plastic bag, which is then dropped into a container holding the product to be cushioned. The rising foam again tends to expand into the available space, but does so inside the bag. Because the bags are formed of flexible plastic, they form individual custom foam cushions for the packaged products. In several techniques, a specific apparatus is used to make the bag from plastic film while concurrently injecting it with foam. Exemplary such apparata are assigned to the assignee of the present invention, and are illustrated, for example, in U.S. Pat. Nos. 5,027,583, 5,376,219, and 6,003,288, the contents of each of which are hereby incorporated entirely herein by reference thereto.

In other packaging applications, similar or identical products are repeatedly placed in similar or identical orientations in similar or identically-sized containers. Such circumstances increase the need for more standard packaging cushions that have a consistent size and shape.

U.S. Pat. Nos. 5,776,510 and 6,386,850, the contents of each of which are hereby incorporated entirely herein by reference thereto, disclose methods and apparatus for automatically molding defined three-dimensional polyurethane foam cushions utilizing the foam-in-place techniques discussed above, but with the added feature of placing a bag containing a foamable composition in a mold as the composition begins to form foam, and maintaining the bag in the mold until the composition has finished forming a foam cushion in a shape conforming to the shape of the inside of the mold, which is often referred to as the “mold image.” Alternatively, a film is used to line the inside of the mold, and then a predetermined amount of foamable composition is deposited onto the film. A second film is typically placed on top of the composition before closing the mold. These inventions have beneficially combined the advantages of on-demand, foam-in-place packaging with the ability to produce standard packaging cushions having a consistent size and shape.

While the forgoing molding techniques have been highly successful, the process for making the individual mold images is cumbersome and time-consuming, requiring careful measurement of the product to be packaged and a labor-intensive effort to form a block of wood, metal or plastic into a mold with a cavity having a precisely-defined mold image. In addition, such molds are conventionally made from solid materials, which tend to retain heat, particularly when the mold is used to make a successive series of molded foam articles. Such heat-retention can result in scorched, partially-melted or otherwise unusable packaging cushions.

Further, for complex and/or deep-draw mold images, the process of placing (“tucking”) the film or bag into the crevices and corners of the mold image can be difficult and ineffective, resulting in molded foam articles that conform poorly to the mold image.

Accordingly, a need exists in the art for an improved method for making molds and mold images, e.g., for foam-in-place packaging, and for improved molds, mold images, and methods of using the same to make molded articles, such as molded foam packaging cushions.

### SUMMARY OF THE INVENTION

That need is met by the present invention, one aspect of which pertains to a method for making a mold, comprising:

a. providing a plurality of contact elements, each contact element having a first end and a second end;

b. assembling the plurality of contact elements in a defined space such that the contact elements are independently movable, with the first ends of the contact elements collectively forming a first surface and the second ends of the contact elements collectively forming a second surface;

c. bringing the first surface into contact with an object such that (1) at least a portion of the first surface assumes an altered contour that substantially conforms to a contour of the object, and (2) the second surface assumes a correspondingly altered contour;

d. joining at least some of the contact elements together so that the joined contact elements are no longer independently movable, thereby securing the altered contour of the second surface as a mold image; and

e. operatively associating a closure with the mold image to form a mold having an enclosable cavity with a defined shape, at least a part of which corresponds to the contour of the object.

Another aspect of the invention pertains to a method for making a molded article, comprising:

a. making a mold from a plurality of contact elements as described immediately above, which includes an enclosable cavity with a defined shape; and

b. dispensing a predetermined amount of a moldable composition into the cavity and positioning the closure such that the moldable composition is enclosed within the cavity, whereby, the moldable composition forms a molded article that at least partially conforms to the defined shape.

A further aspect of the invention is directed to a mold, comprising:

a. a mold image formed from a mold image assembly, the mold image assembly comprising a plurality of contact elements, each contact element having a first end and a second end, the contact elements being assembled in a defined space such that the contact elements are independently movable, with the first ends of the contact elements collectively forming a first surface and the second ends of the contact elements collectively forming a second surface, wherein

(1) the first surface is adapted to be brought into contact with an object such that (a) at least a portion of the first surface assumes an altered contour that substantially conforms to a contour of the object, and (b) the second surface assumes a correspondingly altered contour, and

(2) the contact elements are adapted to be joined together so that the joined contact elements are no longer independently movable, thereby securing the altered contour of the second surface as the mold image; and

b. a closure in operative association with the mold image such that the closure and the mold image together form a mold having an enclosable cavity with a defined shape, at least a part of which corresponds to the contour of the object.

Yet another aspect of the invention is directed to a mold image assembly, comprising a plurality of contact elements, each of the contact elements having a first end, a second end, and an internal passage in fluid communication with the first and second ends, the first and second ends being open such that fluid may flow through the contact elements, the contact elements being assembled in a defined space such that the contact elements are independently movable, with the first ends of the contact elements collectively forming a first surface and the second ends of the contact elements collectively forming a second surface, wherein:

a. the first surface is adapted to be brought into contact with an object such that (1) at least a portion of the first surface assumes an altered contour that substantially conforms to a contour of the object, and (2) the second surface assumes a correspondingly altered contour; and

b. the contact elements are adapted to be joined together so that the joined contact elements are no longer independently movable, thereby securing the altered contour of the second surface as a mold image.

Advantageously, the present invention allows mold images to be quickly and easily made from an assembly of contact elements by simply bringing the first surface of the assembled contact elements into an object of a desired shape, e.g., a product to be packaged. In accordance with a beneficial feature of the invention, some or all of the contact elements can be configured with an internal passage, which allows for improved thermal regulation of the mold cavity, as well as vacuum-assisted/conformal placement of a film inside the mold cavity.

These and other features of the invention may be better understood with reference to the description and drawings set forth below.

### BRIEF DESCRIPTION OF THE DRAWINGS

FIG. 1 is a perspective view of a contact element in accordance with the present invention;

FIG. 2 is a perspective view of an assembly of a plurality of the contact elements shown in FIG. 1;

FIG. 3 is a cross-sectional, elevational view of the assembly shown in FIG. 2, wherein the contact elements are contained within a housing;

FIG. 4 shows the contact element assembly of FIG. 3 in contact with an object;

FIG. 5 is similar to FIG. 4, except that the contact elements are being joined together such that they are no longer independently movable to create a mold image;

FIG. 6 is similar to FIG. 5, except that the mold image is been operatively associated with a closure to form a mold;

FIG. 7 illustrates the dispensation of a foamable composition into the mold of FIG. 6, with a film being interposed between the mold image and foamable composition;

FIG. 8 is similar to FIG. 7, except that the mold is in the closed position while the foamable composition reacts to form a molded foam article within the cavity of the mold;

FIG. 9 illustrates the removal of the molded foam article from the mold;

FIG. 10 illustrates the placement of the molded foam article from FIG. 9 into a container; and

FIG. 11 illustrates the placement of a product in the container of FIG. 10, along with the molded foam article.

### DETAILED DESCRIPTION OF THE INVENTION

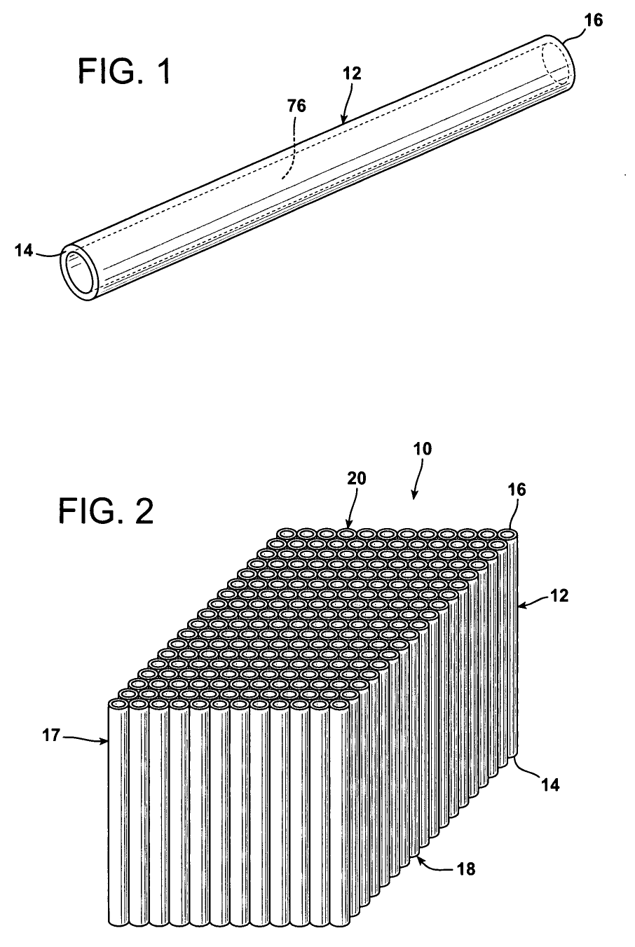

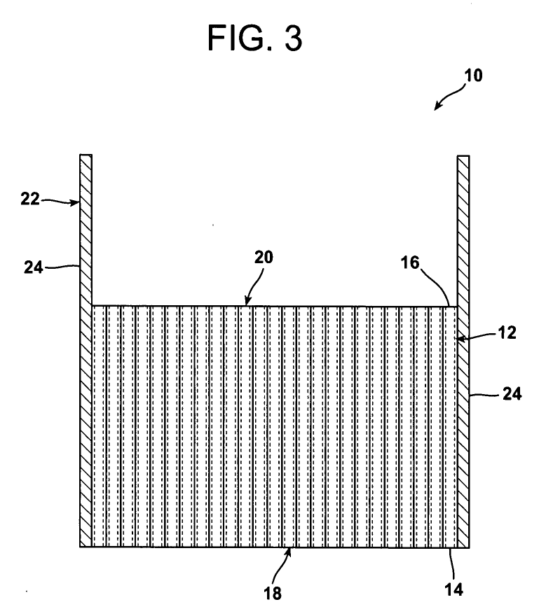

With reference to FIGS. 1-3, a mold image assembly 10 in accordance with the present invention comprises a plurality of contact elements 12. Each contact element 12 has a first end 14 and a second end 16. As illustrated in FIGS. 2-3, the contact elements are assembled in a defined space 17, e.g., in the shape of a rectangular block as shown, such that the first ends 14 of the contact elements 12 collectively form a first surface 18, and the second ends 16 of the contact elements collectively form a second surface 20. Assembly of the contact elements in a defined space 17 may be facilitated by employing physical containment means to contain the plurality of contact elements 12 in a confined space, such as a housing 22 comprising one or more walls 24 as shown in FIG. 3. Other physical containment means, e.g., flexible bands or straps; one or more plates having a plurality of holes (e.g., with one hole for each contact member); magnetic force; an inwardly directed ring of air jets; etc., may also be employed as desired.

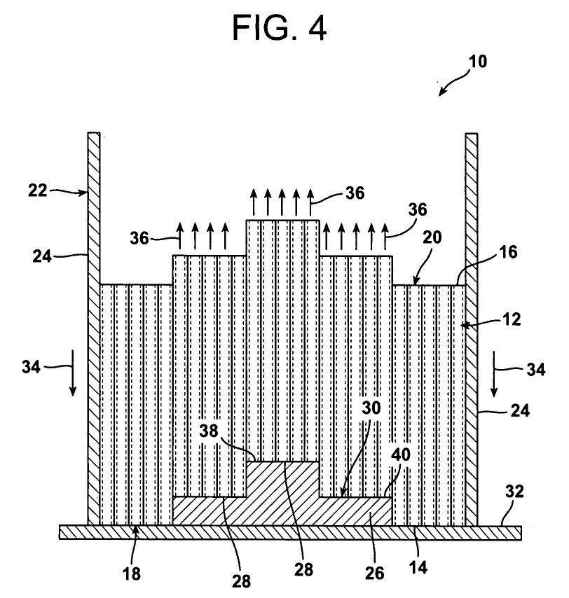

In accordance with the present invention, the contact elements 12 are assembled such that they are independently movable. In this manner, as shown in FIG. 4, when the first surface 18 is brought into contact with an object 26, at least a portion 28 of the first surface 18 assumes an altered contour that substantially conforms to a contour of the object 26, e.g., all or part of the contour formed by the upper surface 30 of object 26. As illustrated, contact between first surface 18 and object 26 may be achieved by placing object 26 on a support surface 32, e.g., a bench, table, or floor, and then moving, e.g., lowering, the mold image assembly 10 in the direction of arrows 34 and onto the object such that some or all of the first surface 18 contacts the upper surface 30 of the object. Because the contact elements 12 are independently movable, those that contact the object 26 (via respective first ends 14) move in a direction 36, which is generally opposite that of direction 34, i.e., away from object 26. Thus, as mold image assembly 10 is generally moved towards and onto the object 26 in direction 34, those contact elements 12 that make contact with the object move away from the object in the direction of arrows 36.

As shown, the extent of movement of the contact elements 12 is dependent upon the contour of upper surface 30: those contact elements in contact with the upper-most regions 38 surface 30 move a greater distance than those in contact with the lower-most areas 40. On the other hand, those contact elements 12 that make no contact at all with object 26, i.e., those outside the periphery of object 26, wherein the respective first ends 14 contact only support surface 32, do not generally move.

The end result is that the first surface 18 is altered from its initial, e.g., flat, contour, such that it substantially conforms to the contour of the object 26. At the same time, because the contact elements 12 are independently movable and, in this embodiment, of substantially the same length, the second surface 20 assumes a correspondingly altered contour, i.e., which approximates that of object 26 on surface 32, as shown in FIG. 4.

The confirmation of the first and/or second surfaces 18, 20 to the contour of the object 26 may be as close or as approximate as desired, depending, e.g., on the spacing between the contact elements; the width, e.g., diameter, of the contact elements in relation to the size, shape, and contour-complexity of the object; the degree to which the length of the contact elements are equal; etc.

An advantage of the present invention is that the contact elements 12 may be quickly and easily assembled in defined space 17, i.e., without the need for elaborate means of assembly, such as perforated guide plates, etc. Thus, as shown in FIG. 2, the contact elements may be assembled such that each contact element 12 is in direct contact with at least one other contact element. While simple, this manner of assembly is quite effective in approximating the contour of object 26 in that the direct contact between the contact elements constrains the independent movement thereof to substantially one dimension. For instance, in the presently illustrated embodiment, the contact elements 12 have a generally elongated shape, and are substantially aligned along their longitudinal dimension, which may be seen to extend along a line between the first and second ends 14, 16. That is, the contact elements are assembled in defined space 17 such that their longitudinal dimensions are generally parallel. In such configuration, each contact element 12 is allowed to move substantially only in a direction that is substantially parallel to the longitudinal dimension of each contact element. In the illustrated embodiment, this constraint of movement contributes to the ability of the assembly of the contact elements to approximate the contour of object 26.

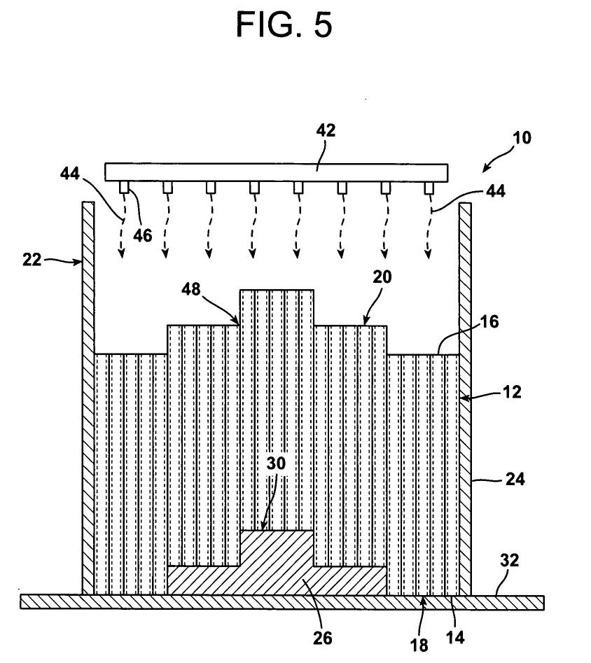

In accordance with the present invention, contact elements 12 are adapted to be joined together so that the joined contact elements are no longer independently movable. In this manner, the altered contour of second surface 20 may be secured, e.g., permanently or temporarily locked in place, as a mold image. The contact elements 12 may be joined as shown in FIG. 5, by bonding the contact elements while the mold image assembly 10 is still in contact with object 26 such that the first and second surfaces 18, 20 have altered contours substantially conforming to that of surface 30 of the object. The bonding means may comprise a thermal bonding device 42 as shown, which transfers heat 44, e.g., via radiation and/or convection, to the contact elements 12 while surfaces 18, 20 are maintained in their altered configuration due to contact with object 26 by first surface 18. Heat 44 may emanate from nozzles 46, e.g., in the form of radiation, heated gas, heated liquid, or a combination of the foregoing.

Thus, when the contact elements 12 are constructed of a material that bonds together, i.e., welds, when the elements are in contact with one another and exposed to sufficient heat, the contact elements 12 that are exposed to heat join together to secure second surface 20 into a mold image 48, as shown in FIG. 5. Suitable materials may include, e.g., various thermoplastic polymeric materials, including polyethylenes, polypropylenes, polycarbonates, etc.

Alternative bonding techniques for joining contact elements 12 include adhesive bonding, magnetic bonding, friction bonding, and/or vibrational bonding. If adhesive bonding is employed, for example, an apparatus similar to the thermal bonding device 42 may be used as in FIG. 5, except that an adhesive material, instead of heat 44, may be sprayed from nozzles 46. In this embodiment, at least some of the adhesive spray may flow between the contact elements to adhesively bond them together while the first and second surfaces are maintained in their altered configurations, which substantially conform to that of object 26. As a further alternative, the adhesive material may simply be poured over the contact elements, e.g., manually. Suitable adhesives include various pressure-sensitive adhesives, UV-curable adhesives, and/or solvent welding materials, such as LOCKTITE Light Curable Polycarbonate 3100 series adhesives, and Weld-On solvent cement from IPS.

Alternatively, a re-settable variation of the present invention may be constructed of ferromagnetic contact elements 12, such as steel tubing, so that when a magnetic field (either by electromagnetic or permanent magnet means) is applied to such elements, the magnetic fields induced in each element will temporarily bond the elements into a unitary structure. A ferromagnetic housing 22 may also be used to add further rigidity and structure to this variation of the invention.

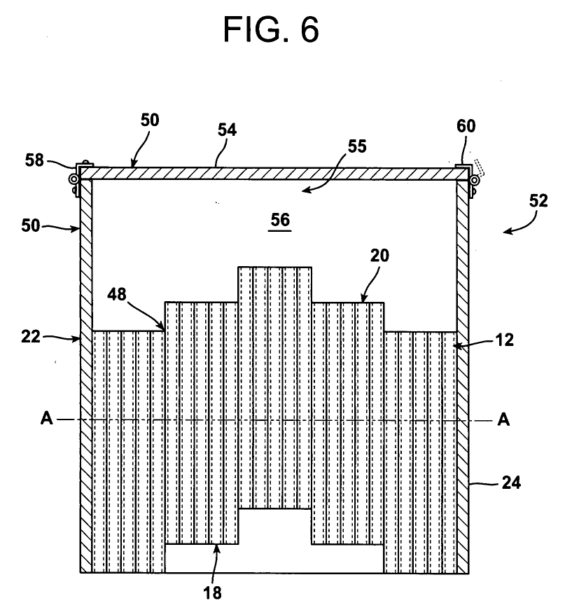

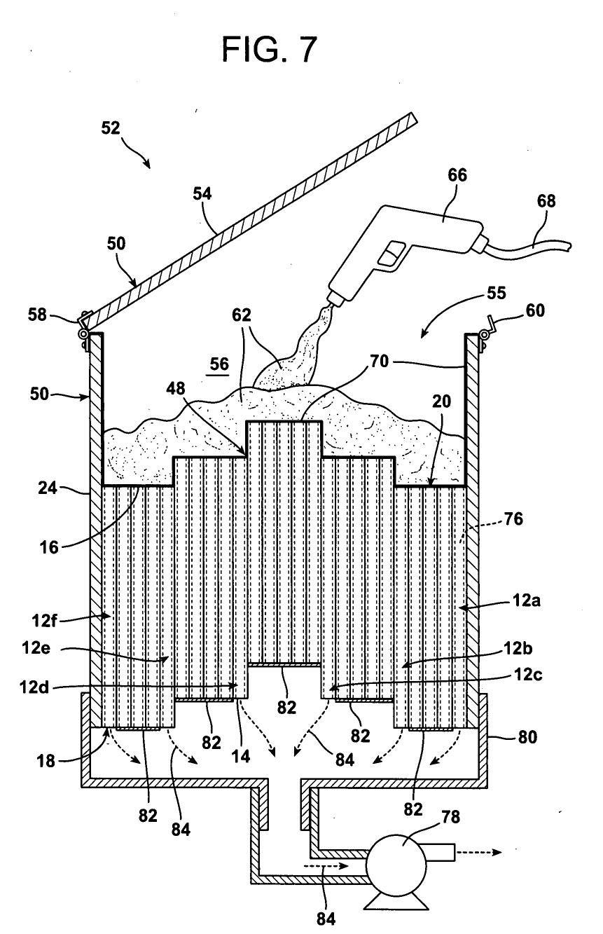

As may be appreciated from the foregoing description, mold image assembly 10 is adapted to form mold image 48, the surface 20 of which corresponds to the contour of upper surface 30 of object 26. As such, the resultant mold image 48 may be associated with a suitable closure 50 to form a mold 52, e.g., as shown in FIG. 6. Preferably, the closure 50 is operatively associated with the mold image 48 such that the mold 52 may assume either a closed configuration, as shown in FIG. 6, or an open configuration, as shown in FIG. 7.

In the illustrated embodiment, closure 50 includes a lid 54 pivotally attached to housing 22 adjacent opening 55 thereof. An advantage of this embodiment is that it is economical, in that the housing 22 of mold image assembly 10 is also used as part of the closure 50 for mold 52. The closure and/or lid may be made from various metals, plastics, or woods.

In other embodiments, the mold image 48 may be completely separated from housing 22, and operatively associated with a separate closure, e.g., with a separate lid and housing, such as by placing the mold image within such housing. This embodiment may advantageously be employed, e.g., with packaging lines having dedicated mold housings, wherein different mold images are used with such housings to make a desired number of molded foam articles of a particular shape, which is determined, at least in part, by the contour of the mold image. When the desired number of molded articles are produced, the mold image may be supplanted in the mold housing by a different mold image, which may be prepared in accordance with the present invention from a differently-shaped object to produce a differently-shaped article. As may thus be appreciated, the present invention allows new mold images to be quickly and easily produced, so that a dedicated mold closure (e.g., housing and lid) and foaming apparatus can produce an unlimited variety of custom-shaped molded articles.

A further alternative embodiment is to separate the mold image 48 from the mold image assembly 10, and then build a closure around the mold image to form an entirely new mold.

In yet another alternative embodiment of the invention, mold image 48 may be separated from first surface 18. This may be accomplished by severing the contact elements 12 between the first surface 18 and second surface 20, e.g., through the contact elements along line A-A as shown in FIG. 6. The contact elements may be severed by any suitable means, e.g., cutting and/or melting, such as with a heated or unheated blade, wire, band saw, knife, etc. This technique may be employed with any of the embodiments described above, and may be optionally employed, e.g., when space constraints in existing mold housings, or heat-transfer demands (discussed below) make such a technique advantageous. If desired, the separated first surface 18 may be retained as a ‘negative image’ of object 26, which can be used to create a copy of the ‘positive’ mold image 48.

Regardless of the particular embodiment selected to operatively associate a closure with the mold image, the closure and mold image together form a mold having an enclosable cavity with a defined shape. In the embodiment illustrated in FIG. 6, for example, i.e., wherein the closure 50 includes a lid 54 pivotally attached to housing 22 from mold image assembly 10, the resultant mold 52 has an enclosable cavity 56 with a defined shape, at least a part of which corresponds to the contour of object 26, i.e., by virtue of the correspondence of surface 20 of mold image 48 to surface 30 of object 26. In such embodiment, the cavity 56 may be enclosable by the operation of lid 54, which is positionable with respect to opening 55 such that housing 22, lid 54, and mold image 48 together form the enclosable cavity 56. For example, lid 54 may be pivotally attached to housing 22 adjacent opening 55 via one or more hinges 58. A locking mechanism 60 for lid 54 may be employed to fully enclose the cavity 56, e.g., when mold 52 assumes the closed position as shown in FIG. 6.

Accordingly, a method for making a mold 52 in accordance with the present invention comprises:

a. providing a plurality of contact elements 12;

b. assembling the contact elements 12 in a defined space 17 such that the contact elements are independently movable, with the first ends 14 of the contact elements collectively forming first surface 18 and the second ends 16 of the contact elements collectively forming second surface 20;

c. bringing first surface 18 into contact with an object, e.g., object 26, such that (1) at least a portion 28 of the first surface assumes an altered contour that substantially conforms to contour 30 of object 26, and (2) second surface 20 assumes a correspondingly altered contour;

d. joining at least some of the contact elements together so that the joined contact elements are no longer independently movable, thereby securing the altered contour of second surface 20 as a mold image 48; and

e. operatively associating a closure, e.g., closure 50, with mold image 48 to form mold 52 having an enclosable cavity 56 with a defined shape, at least a part of which corresponds to the contour 30 of object 26.

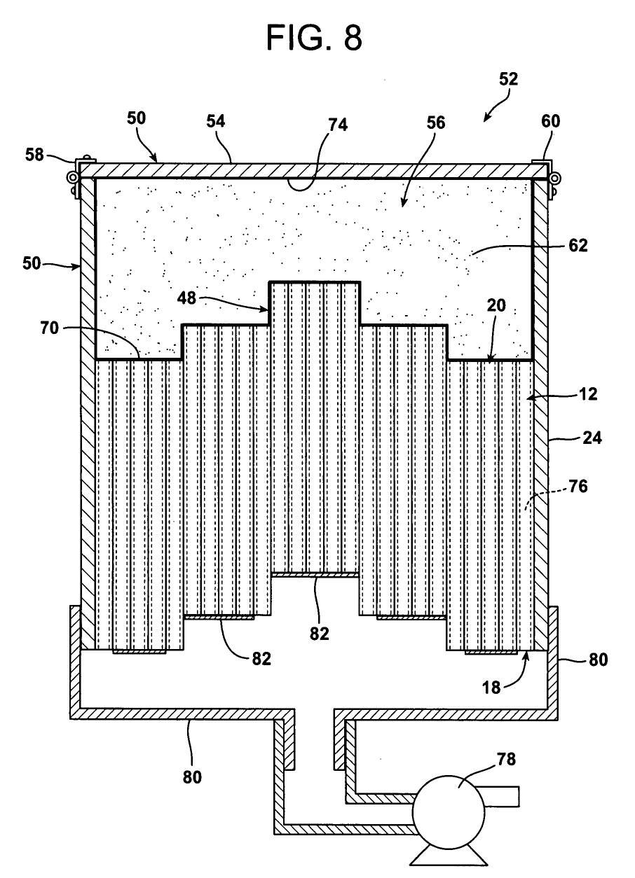

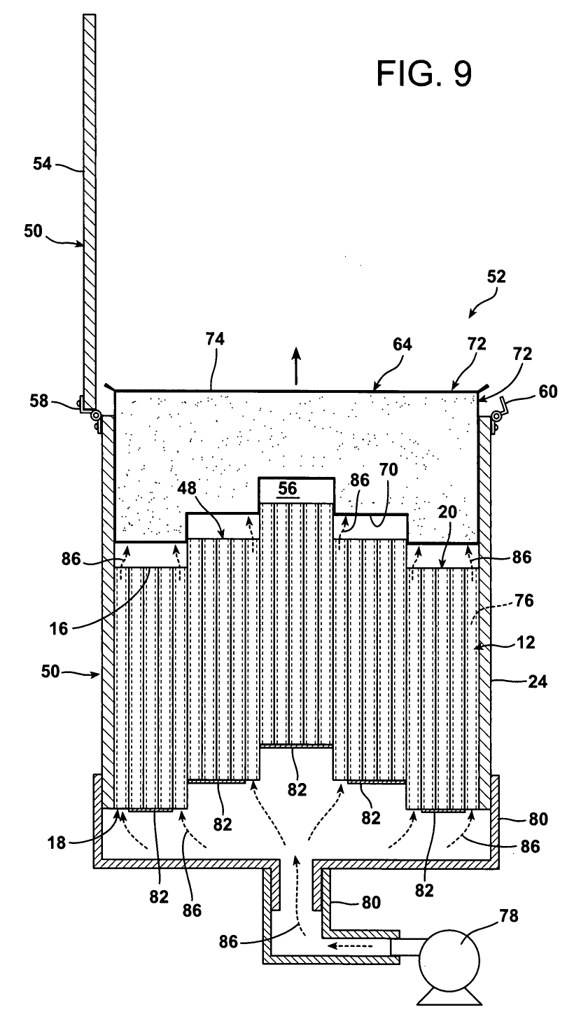

Mold 52 or other mold prepared in accordance with the present invention may be used to make a molded article by dispensing a predetermined amount of a moldable, e.g., foamable, composition 62 into cavity 56 (FIG. 7), and positioning closure 50 such that the foamable composition 62 is enclosed within the cavity 56 (FIG. 8). In this manner, the composition 62 forms a molded article 64 that at least partially conforms to the shape of cavity 56 (FIG. 9).

In many embodiments, moldable composition 62 is a foamable composition, which generally conforms to the shape of cavity 56 by expanding within the cavity until it substantially completely fills the interior volume thereof. By positioning the closure 50 such that the composition 62 is enclosed within the cavity (FIG. 8), the closure and mold image 48 cooperate to constrain the expansion of the foamable composition and thereby force its confirmation to the shape of the cavity 56. Once the foamable composition cures into a foam, it becomes a molded foam article 64. For convenience, further reference to the composition 62 and molded article 64 will be in regards to a foamable composition and molded foam article, respectively. However, this convention should not be construed as a limitation of the invention.

A hand-held device 66 may be used to dispense foamable composition 62 into the cavity 56. Foamable composition 62 may comprise a mixture of at least one polyol and at least one isocyanate, which may be supplied to device 66, e.g., separately, via one or more hoses 68 (only one shown). When mixed, the polyol and isocyanate react within cavity 56 to form a polyurethane foam, as described more fully, e.g., in U.S. Pat. No. 6,034,197, the disclosure of which is hereby incorporated herein by reference thereto.

Suitable hand-held devices for mixing polyols and isocyanates and dispensing the resultant reactive mixture are well known in the art, including those devices disclosed, e.g., in U.S. Pat. Nos. 3,945,569, 4,023,733, and 4,426,023, the disclosures of which are hereby incorporated herein by reference thereto. Other suitable devices, which may be incorporated into hand-held dispensers or, e.g., mounted on a stand for automated or semi-automated operations, are disclosed in U.S. Pat. Nos. 5,255,847, 5,950,875, 6,929,193, and 6,996,956, the disclosures of which are hereby incorporated herein by reference thereto.

The invention may also be used in conjunction with automated molding machines, such as those disclosed in the above-incorporated U.S. Pat. Nos. 5,776,510 and 6,386,850, and also with the automated molding machines disclosed in U.S. Ser. No. 11/411,708, filed Apr. 26, 2006 and U.S. Ser. No. 11/414,972, filed May 1, 2006, the disclosures of which are hereby incorporated herein by reference thereto.

Other types of foam may also be dispensed as desired into cavity 56, including foams comprising, e.g., polyesters, such as polyethylene terephthalate, polyolefins, such as polyethylene homopolymer, polyethylene copolymer, polypropylene homopolymer, polypropylene copolymer; polystyrenes; etc.

In some embodiments of the invention, a film 70 may be interposed between the mold image 48 and the foamable composition 62 (see FIG. 7), such that the film forms at least a partial outer skin 72 for the molded foam article 64 (see FIG. 9). This may be advantageous when the foamable composition 62 and resultant foam has adhesive properties, such that it would otherwise adhere to the mold image 48, thereby making it difficult to remove the resultant molded foam article from the mold 52. A mixture of an isocyanate and a polyol, for example, has a relatively high degree of adhesion towards many types of surfaces. The interposition of film 70 between the mold image 48 and foamable composition 62 prior to dispensing the foamable composition into cavity 56 prevents, or at least reduces, adhesion between the foamable composition/article 64 and mold image. For the same reason, a sufficiently large piece of film may be employed so that the film 70 is also interposed between the mold walls 24 and the foamable composition 62, as shown in FIG. 7, i.e., to prevent or reduce adhesion between the foamable composition/article 64 and the mold walls. Also for the same reason, a separate film 74, or an extension of film 70, may be interposed between the lid 54 and foamable composition 62, e.g., at some point prior to moving the lid to the closed position as shown in FIG. 8.

Films 70 and/or 74 may comprise any flexible material that can contain the foamable composition 62 and be manipulated as described herein to produce molded foam articles. Examples of such materials include various thermoplastic materials, e.g., polyethylene homopolymer or copolymer, polypropylene homopolymer or copolymer, etc. Non-limiting examples of suitable thermoplastic polymers include polyethylene homopolymers, such as low density polyethylene (LDPE) and high density polyethylene (HDPE), and polyethylene copolymers such as, e.g., ionomers, EVA, EMA, heterogeneous (Zeigler-Natta catalyzed) ethylene/alpha-olefin copolymers, and homogeneous (metallocene, single-cite catalyzed) ethylene/alpha-olefin copolymers. Ethylene/alpha-olefin copolymers are copolymers of ethylene with one or more comonomers selected from C₃ to C₂₀ alpha-olefins, including linear low density polyethylene (LLDPE), linear medium density polyethylene (LMDPE), very low density polyethylene (VLDPE), and ultra-low density polyethylene (ULDPE). Various other polymeric materials may also be used for films 70 and/or 74, such as, e.g., polypropylene homopolymer or polypropylene copolymer (e.g., propylene/ethylene copolymer), polyesters, polystyrenes, polyamides, polycarbonates, etc. The film may be monolayer or multilayer and can be made by any known extrusion process by melting the component polymer(s) and extruding, coextruding, or extrusion-coating them through one or more flat or annular dies.

In some embodiments of the invention, contact elements 12 may have an internal passage 76 in fluid communication with the first and second ends 14, 16. In addition, the first and second ends 14, 16 may be open such that fluid can flow through the contact elements. As perhaps best shown in FIG. 1, the contact elements may thus be shaped in a tubular fashion, e.g., like drinking straws, with a length dimension and a width dimension. As shown, the internal passage 76 may be disposed along the length dimension of the contact elements 12. The cross-sectional width may have any desired shape, e.g., round (as illustrated), oval, square, rectangular, triangular, etc.

Providing internal passages 76 in the contact elements 12 may be advantageous for molding applications in which temperature regulation is a factor. For instance, when the foamable composition 62 is a mixture of polyol(s) and isocyanate(s), the foaming reaction is exothermic. When making a series of molded foam articles from such composition, heat must be continually removed from the mold in order to prevent the build-up of heat in the mold, which can result in scorching/melting of the molded article and/or improper foam formation. The internal passages in the contact elements 12, and therefore in the mold image 48, allow heat to be readily removed from the mold for improved temperature regulation within the cavity 56.

The provision of internal passages 76 in the contact elements 12 may also be advantageous when film 70 is interposed between the mold image 48 and the foamable composition 62, as shown in FIG. 7. As noted above, film 70 may be placed in the mold cavity 56 to prevent adhesion between the mold image 48 and/or walls 24. In some embodiments, it is desirable for the film 70 to conform relatively closely to the contour of mold image 48. In general, the more closely the film 70 conforms to the contour of mold image 48, the more closely will the resultant molded foam article 64 correspond to the shape of the object 26. One way to accomplish this is to place a vacuum source in fluid communication with mold cavity 56, e.g., in such a manner that a vacuum is applied in the space between the surface 20 of mold image 48 and the film 70, which may exist after the film is initially positioned, e.g., manually, inside the mold cavity 56.

One embodiment for applying such a vacuum is illustrated in FIG. 7, in which a vacuum source communicates with cavity 56 through one or more of the contact elements 12. The vacuum source may include a vacuum pump 78, which communicates with mold 52 via manifold 80. Manifold 80 may be affixed to mold 52 adjacent the first surface 18 of the contact elements 12 as shown such that it is in fluid communication with the second ends 16 thereof. When contact elements 12 are constructed with an internal passage 76, a vacuum may be pulled through the contact elements as illustrated. That is, as shown in FIG. 7, when vacuum pump 78 is activated, air that may be trapped within one or more spaces between film 70 and surface 20 of mold image 48 may be pulled from such space(s) through one or more of the contact elements 12, and into the vacuum pump 78 via manifold 80. For each contact element 12 through which air flows in this manner, the air enters the contact element at second end 16, travels through the internal passage 76, and then exits the contact element at first end 14.

If desired, the contact elements may be configured such that only a predetermined number of them communicate with vacuum pump 78. This may be done, for example, to concentrate the pull of the vacuum in those areas in which it is the most difficult to force film 70 into confirmation with the contour of mold image 48, e.g., in corners or other transition areas in which the shape of the mold image changes. In the embodiment illustrated in FIG. 7, for instance, the second ends 16 of each of contact elements 12a, 12b, 12c, 12d, 12e, and 12f are positioned at corners in the mold image 48. One way to cause the film 70 to be pulled as fully as possible into such corners is to increase the vacuum force through contact elements 12a-f. This may be accomplished by covering the first ends 14 of the other contact elements in mold 52, e.g., with covers 82 as shown, such that all the vacuum pulling power from vacuum pump 78 is applied substantially only through contact elements 12a-f, such that air, represented by arrows 84, is pulled substantially only through such contact elements 12a-f. By concentrating the vacuum power in this manner, film 70 may be more effectively pulled into the corners and other transitional areas of mold image 48 as shown.

Covers 82 may be formed from, e.g., masking tape, adhesively affixed plates, etc. Alternatively, the contact elements through which vacuum is not intended to be pulled may be fully or partially filled with a material, e.g., caulk, glue, etc., to substantially prevent fluid flow through the internal passages 76 thereof. As a further alternative, if the contact elements are severed to separate the first surface 18 from the second surface 20, e.g., along line A-A as described above (see FIG. 6), a single masking sheet may be applied to first surface 18, with openings patterned to allow vacuum to be pulled only through predetermined contact elements, i.e., those having second ends 16 at corners or other transition areas on second surface 20 of mold image 48.

Regardless of whether and/or how films 70 and 74 are applied to mold cavity 56 and lid 54, respectively, once a desired amount of foamable composition 62 has been dispensed into the cavity 56, lid 54 may be moved to the closed position as shown in FIG. 8, and secured in such position via locking mechanism 60 as shown. Such closed position serves to contain the foamable composition 62 as it expands within cavity 56. The mold is preferably maintained in the closed position until the foaming reaction is substantially complete. During this time, vacuum pump 78 may be kept running or, as shown, shut off.

When the foaming reaction is complete, molded foam article 64 is produced, which at least partially conforms to the shape of mold cavity 56. In the illustrated embodiment, films 70 and 74 form at least a partial outer skin for the article 64.

Access to article 64 in cavity 56 may be provided by moving lid 54 to an open position, as shown in FIG. 9. Removal of the article may be facilitated by placing a positive-pressure source in fluid communication with mold cavity 56, e.g., by communicating with the cavity through some or all of the contact elements in a similar manner as described above in connection with vacuum pump 78 and manifold 80. Thus, as shown in FIG. 9, manifold 80 and pump 78 may be used in the opposite manner that they are used in FIG. 7. That is, instead of pulling air 84 from cavity 56 in order to force film 70 into confirmation with mold image 48, the operation of pump 78 may be reversed once the foam article 64 has been completed, to generate positive pressure and thereby force air, represented by arrows 86, into the cavity 56. Advantageously, pump 78, or other positive pressure source, may generate sufficient pressure that the force of air 86 on the underside of the of the molded article 64 is sufficient to at least partially move the article out of cavity 56, whereupon the article may be manually or automatically transported to an intended destination, e.g., a packaging application.

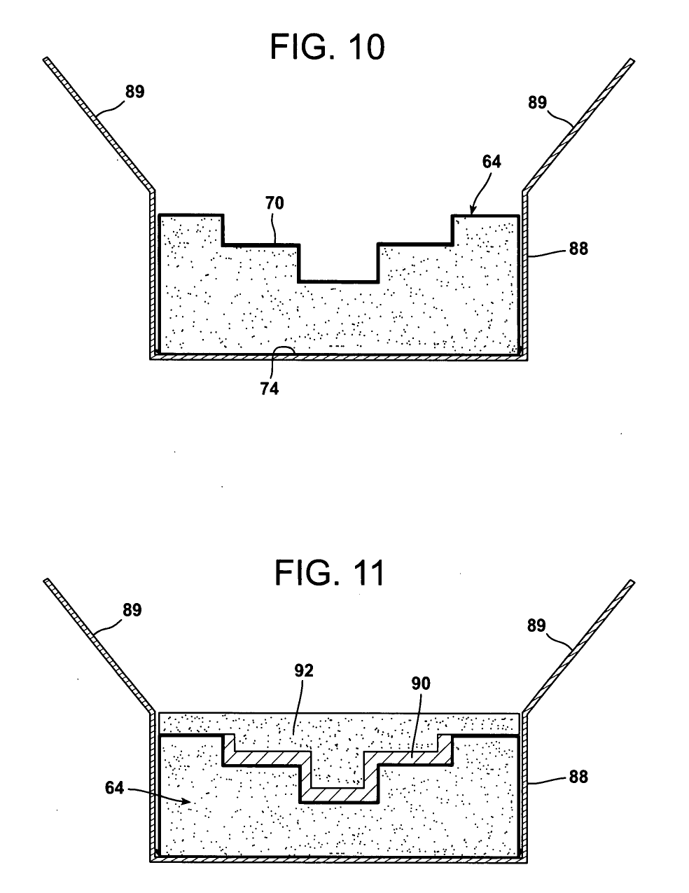

For example, the molded article 64 may be placed in a container 88, e.g., a shipping container such as a corrugated box or the like, as illustrated in FIG. 10. Within container 88, molded article 64 may have an inverted orientation as shown, relative to its orientation in mold 52.

As shown in FIG. 11, a product 90 may be placed in container 88 along with molded foam article 64 in order to package such product, e.g., for shipment to an intended destination. Advantageously, the three-dimensional shape of object 26 may be selected to correspond, at least partially, to that of the product 90 to be packaged so that the product may be securely ensconced within the molded foam article 64 in container 88 as shown. When the molded foam article 64 is employed as a packaging cushion in this manner, the ‘custom fit’ between the article 64 and product 90 provides an optimal level of protection for the product. Additional protection may be provided by including a second cushion 92 in container 88 as shown, e.g., a ‘foam-in-bag’ cushion as described in the above-incorporated patents, in order to fill any remaining void spaces within the container 88.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A method for making a mold, comprising:
a. providing a plurality of contact elements, each contact element having a first end and a second end, said contact elements having an internal passage in fluid communication with said first and second ends, said first and second ends being open such that fluid may flow through said contact elements;
b. assembling said plurality of contact elements in a defined space such that said contact elements are independently movable, with the first ends of said contact elements collectively forming a first surface and the second ends of said contact elements collectively forming a second surface;
c. bringing said first surface into contact with an object such that (1) at least a portion of said first surface assumes an altered contour that substantially conforms to a contour of the object, and (2) said second surface assumes a correspondingly altered contour;
d. joining at least some of said contact elements together so that the joined contact elements are no longer independently movable, thereby securing the altered contour of said second surface as a mold image;
e. operatively associating a closure with said mold image to form a mold having an enclosable cavity with a defined shape, at least a part of which corresponds to the contour of the object;
f. placing a vacuum source in fluid communication with said cavity, said vacuum source capable of pulling a vacuum to induce fluid flow through the internal passages of said contact elements; and
g. configuring said contact elements such that said vacuum source communicates with said cavity through only a predetermined number of said contact elements, while preventing fluid flow through the internal passages of the remainder of said contact elements, wherein fluid is pulled substantially only through said predetermined contact elements.

2. (canceled)

3. (canceled)

4. (canceled)

5. The method of claim 1, further including placing a positive-pressure source in fluid communication with said cavity.

6. The method of claim 5, wherein said positive-pressure source communicates with said cavity through a predetermined number of said contact elements.

7. The method of claim 1, wherein each of said contact elements is in direct contact with at least one other contact element.

8. The method of claim 7, wherein said contact elements are assembled such that direct contact therebetween constrains the independent movement thereof to substantially one dimension.

9. The method of claim 1, wherein said contact elements are joined by adhesive bonding, heat bonding, magnetic bonding, friction bonding, or vibrational bonding.

10. The method of claim 1, further including separating said mold image from said first surface.

11. A method for making a molded article, comprising:
a. providing a plurality of contact elements, each contact element having a first end and a second end, said contact elements having an internal passage in fluid communication with said first and second ends, said first and second ends being open such that fluid may flow through said contact elements;
b. assembling a plurality of contact elements in a defined space such that said contact elements are independently movable, with the first ends of said contact elements collectively forming a first surface and the second ends of said contact elements collectively forming a second surface;
c. bringing said first surface into contact with an object such that (1) at least a portion of said first surface assumes an altered contour that substantially conforms to a contour of the object, and (2) said second surface assumes a correspondingly altered contour;
d. joining at least some of said contact elements together so that the joined contact elements are no longer independently movable, thereby securing the altered contour of said second surface as a mold image;
e. operatively associating a closure with said mold image to form a mold having an enclosable cavity with a defined shape, at least a part of which corresponds to the contour of the object; and
f. dispensing a predetermined amount of a moldable composition into said cavity and positioning said closure such that the moldable composition is enclosed within said cavity, said moldable composition producing an exothermic reaction within said cavity and generating heat therein, said internal passages of said contact elements facilitating the removal of said heat from said cavity to improve the temperature regulation thereof;
whereby, the moldable composition forms a molded article that at least partially conforms to said defined shape.

12. (canceled)

13. The method of claim 11, further including placing a vacuum source in fluid communication with said cavity.

14. The method of claim 13, wherein said vacuum source communicates with said cavity through a predetermined number of said contact elements.

15. The method of claim 11, further including placing a positive-pressure source in fluid communication with said cavity.

16. The method of claim 15, wherein said positive-pressure source communicates with said cavity through a predetermined number of said contact elements.

17. The method of claim 11, wherein said closure comprises a housing with an opening, and a lid positionable with respect to said opening such that said housing, lid, and mold image together form said enclosable cavity.

18. The method of claim 11, further including interposing a film between the mold image and the moldable composition such that said film forms at least a partial outer skin for the molded article.

19. The method of claim 11, further comprising placing said molded article in a container along with a product to be packaged within the container.

20. The method of claim 19, wherein the shape of said object corresponds at least partially to that of the product to be packaged.

21. The method of claim 11, wherein said moldable composition is a foamable composition comprising a mixture of at least one polyol and at least one isocyanate.

22. A mold, comprising:
a. a mold image formed from a mold image assembly, said mold image assembly comprising a plurality of contact elements, each contact element having a first end and a second end, said contact elements being assembled in a defined space such that said contact elements are independently movable, with the first ends of said contact elements collectively forming a first surface and the second ends of said contact elements collectively forming a second surface, wherein
(1) said first surface is adapted to be brought into contact with an object such that (a) at least a portion of said first surface assumes an altered contour that substantially conforms to a contour of the object, and (b) said second surface assumes a correspondingly altered contour, and
(2) said contact elements are adapted to be joined together so that the joined contact elements are no longer independently movable, thereby securing the altered contour of said second surface as said mold image; and
b. a closure in operative association with said mold image such that said closure and said mold image together form a mold having an enclosable cavity with a defined shape, at least a part of which corresponds to the contour of the object.

23. A mold image assembly, comprising a plurality of contact elements, each of said contact elements having a first end, a second end, and an internal passage in fluid communication with said first and second ends, said first and second ends being open such that fluid may flow through said contact elements, said contact elements being assembled in a defined space such that said contact elements are independently movable, with the first ends of said contact elements collectively forming a first surface and the second ends of said contact elements collectively forming a second surface, wherein:
a. said first surface is adapted to be brought into contact with an object such that (1) at least a portion of said first surface assumes an altered contour that substantially conforms to a contour of the object, and (2) said second surface assumes a correspondingly altered contour; and
b. said contact elements are adapted to be joined together so that the joined contact elements are no longer independently movable, thereby securing the altered contour of said second surface as a mold image.

24. A method for making a molded article, comprising:
a. providing a plurality of contact elements, each contact element having a first end and a second end;
b. assembling a plurality of contact elements in a defined space such that said contact elements are independently movable, with the first ends of said contact elements collectively forming a first surface and the second ends of said contact elements collectively forming a second surface;
c. bringing said first surface into contact with an object such that (1) at least a portion of said first surface assumes an altered contour that substantially conforms to a contour of the object, and (2) said second surface assumes a correspondingly altered contour;
d. joining at least some of said contact elements together so that the joined contact elements are no longer independently movable, thereby securing the altered contour of said second surface as a mold image;
e. interposing a film between the mold image and the moldable composition;
f. operatively associating a closure with said mold image to form a mold having an enclosable cavity with a defined shape, at least a part of which corresponds to the contour of the object; and
g. dispensing a predetermined amount of a moldable composition into said cavity and positioning said closure such that the moldable composition is enclosed within said cavity,
whereby, the moldable composition forms a molded article that at least partially conforms to said defined shape, wherein said film forms at least a partial outer skin for the molded article.

25. A method for making a mold, comprising:
a. providing a plurality of contact elements, each contact element having a first end and a second end;
b. assembling said plurality of contact elements in a defined space such that said contact elements are independently movable, with the first ends of said contact elements collectively forming a first surface and the second ends of said contact elements collectively forming a second surface;
c. bringing said first surface into contact with an object such that (1) at least a portion of said first surface assumes an altered contour that substantially conforms to a contour of the object, and (2) said second surface assumes a correspondingly altered contour;
d. joining at least some of said contact elements together so that the joined contact elements are no longer independently movable, thereby securing the altered contour of said second surface as a mold image;
e. separating said mold image from said first surface by severing said contact elements between said first and second surfaces; and
f. operatively associating a closure with said mold image to form a mold having an enclosable cavity with a defined shape, at least a part of which corresponds to the contour of the object.
